(19) United States
(12) Patent Application Publication
(10) Pub. No.: US 2004/0136071 A1
(43) Pub. Date: Jul. 15, 2004

(54) Diffractive optics assembly in an optical signal multiplexer/demultiplexer

(76) Inventors: William W. Morey, Northridge, CA (US); Xuegong Deng, Piscataway, NJ (US); Ray T. Chen, Austin, TX (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/691,466

(22) Filed: Oct. 22, 2003

Related U.S. Application Data
(60) Provisional application No. 60/420,841, filed on Oct. 23, 2002.

(51) Int. Cl. G02B 5/18

(52) U.S. Cl. 359/566; 398/87

(57) ABSTRACT

A diffractive optics system for wavelength division multiplexing and demultiplexing optical signals. The present system can be employed in multiplexers, demultiplexers, spectrum analyzers, and the like. In one embodiment, the diffractive optics system includes a waveguide array, a lens assembly, first and second diffractive optical elements (“DOEs”), and a reflector. In a demultiplexing operation, a multiplexed optical signal is input into the system via an input waveguide in the waveguide array. The signal is focused by the lens assembly, then transmitted through the first and second DOEs, where diffraction of the signal and separation of its constituent wavelength-distinct channels occurs. The channels are then reflected by the reflector back through the first and second DOEs, after which each channel is directed by the lens assembly to one of a plurality of output waveguides located in the waveguide array. A conversely similar process is followed for producing a multiplexed optical signal.

### CROSS-REFERENCE TO RELATED APPLICATIONS

This application claims priority to and the benefit of U.S. Provisional Application No. 60/420,841, filed Oct. 23, 2002, and entitled “Diffractive-Optics-Based Free-Space Wavelength Division Multiplexer/Demultiplexer for Ultra-High Data Rate Communications,” which is incorporated herein by reference in its entirety.

### BACKGROUND OF THE INVENTION

1. The Field of the Invention

The present invention generally relates to fiber optic wavelength division multiplexing and demultiplexing in multi-wavelength telecommunication modules, subsystems, and systems. In particular, the present invention relates to systems and methods that enable the multiplexing and demultiplexing of optical signals at rates utilized in high speed optical communications networks.

2. The Related Technology

Increasing demand for high-speed, broadband communications has resulted in a rapid increase in fiber optic communication systems that require faster and more reliable data transfer rates. Grating-based wavelength-division multiplexers/demultiplexers are commonly used for high speed communication networks. However, the continuously increasing demand for speed and bandwidth is rapidly approaching the outer boundaries of what conventional grating-based wavelength division multiplexers/demultiplexers (MUX/DeMUX) can provide in terms of high data rate transmission and communication. This constraint is due in part to limitations in the extent to which inter-fiber spacing and numerical aperture (NA) can be effectively optimized in known MUX/DeMUX devices.

Many of the attempts to improve the data rate of MUX/DeMUX devices have centered around modifications to inter-fiber spacing. Inter-fiber spacing represents the proximity with which fibers are positioned with respect to one another in order to receive and transmit optical signal channels. Fibers that are packed more closely together can, in some instances, increase the allowed data rate per channel due to the minimization of delay times between channels. Such packaging comes at a cost, however. Closely packing fibers makes it difficult to direct an optical signal into each of the fibers without excessive signal loss and cross talk. This situation is exacerbated by inherent variations in fiber diameter and the current inability to satisfactorily eliminate such variations.

Another method for increasing MUX/DeMUX data rates involves employing specialized waveguide fan-in structures. Such structures allow for a closer inter-fiber spacing by facilitating the transition from a large fiber bundle to the positioning and precise alignment of discrete fibers with respect to neighboring fibers at the fiber end-MUX/DeMUX interface. Unfortunately, such devices are often bulky and inconvenient, which prevents their widespread use.

Yet another attempt at improving MUX/DeMUX device data rates involves reducing the NA of the fibers used in connection with such devices. This alternative also suffers from some disadvantages, however. First, the degree to which fiber NA can be reduced is limited by virtue of the optical signal diffraction that is performed within the system. Moreover, reduction of fiber NA correspondingly increases the difficulty in aligning the fibers for transmission and receipt of optical signals to and from the MUX/DeMUX device.

In light of the above, a need exists for diffractive structures and systems that can be used in connection with multiplexing, demultiplexing, and other devices, and that enable high data rate operation to match current and future data transfer capacities.

### BRIEF SUMMARY OF THE INVENTION

The present invention has been developed in response to the above and other needs in the art. Briefly summarized, embodiments of the present invention are directed to a system and method for multiplexing and demultiplexing optical signals. The present invention finds application with optically-based devices, including multiplexer/demultiplexer devices, spectrum analyzers, and spectrometers. Also, the present invention has a compact design, which affords its use in a variety of applications where space is limited.

Significantly, the present system and method for optical signal multiplexing/demultiplexing is capable of operating at high data rates, in some embodiments at rates of at least 40 Gbps. This high data rate capability enables the invention to be employed in current and future optical communication and telecommunication networks, where high speed is a critical factor.

In one embodiment, the present invention includes a diffractive optics system including a waveguide array, a directing element, first and second diffractive optical elements (“DOEs”), and a reflector. These elements are arranged to lie within an optical path defined by optical signals entering and/or exiting the waveguide array. The first and second DOEs are positioned along the optical path in angled configurations one with another, and both are also angled with respect to the directing element and the reflector.

Each DOE includes one of a variety of possible diffractive structures. In one embodiment, the first and second DOEs are transmissive binary diffraction gratings. In other embodiments, the DOEs can include holographic, surface-relief, computer-generated, or other transmissive grating structures. In the present embodiments, the DOEs are optically transmissive to enable operation of the system.

During a demultiplexing operation, a multiplexed optical signal having a combined plurality of wavelength-distinct channels is inputted into the system via an optical fiber that is positioned within the waveguide array. The inputted multiplexed optical signal is collimated by the directing element and then directed to the first DOE, which is positioned at an angle with respect to the directing element. A first diffractive transmission through the first DOE causes the multiplexed optical signal to disperse into its constituent channels.

Following initial dispersion, the diffracted channels are directed to the second DOE, which is angled with respect to the first DOE. Transmission through the second DOE further disperses the channels before they are reflected and redirected in the opposite direction by the reflector. Redirection by the reflector then causes each of the channels to pass once again through the second and first DOEs in succession, thereby additionally dispersing the channels. Finally, the dispersed channels are focused again by the directing element, which directs each channel to a respective output fiber positioned in the waveguide assembly, wherein one output fiber is positioned for each channel separated from the multiplexed optical signal. Once received by the proper fiber, each channel can be transmitted as needed, such as to an optical communications network or optical device. A similar converse process is followed in combining multiple wavelength-distinct channels into a multiplexed optical signal in a multiplexing scheme of the present invention.

The present invention offers several advantages. Among them is the compactness of the diffractive optic design. Because each of the above-mentioned elements is angled with respect to one another, a folded “U”-shaped design is formed. This reduces the dimensional requirements needed for the system, thereby enabling it to be located in relatively small package sizes. Thus, use of the system in small devices, such as hand-held spectrum analyzers, is enabled. In addition, the system does not suffer from insertion loss or polarization dependent loss known to hamper other MUX/DeMUX systems. Further, the present system enables high diffraction efficiency to be achieved due to improved system design. Finally, the use of diffractive optical elements makes mass production of the present system practical, cost-effective, and thus preferable in the communication industry.

The structure and techniques disclosed herein may be used in active and passive components, such as fiber-optic configurable add-drop modules using MUX/DMUX, wavelength-selective and/or wavelength-dependent devices with fiber at input and/or output interfaces, and hand-held spectrum analyzers.

In one embodiment of the present invention, therefore, a diffractive optics system is disclosed, comprising a directing element for directing an inputted optical signal, means for repeatedly transmitting and diffracting the directed optical signal into multiple channels of distinct wavelengths, and a reflector that reflects the multiple r_channels received from the means for repeatedly transmitting and diffracting back toward the means for repeatedly transmitting and diffracting.

These and other features of the present invention will become more apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram illustrating several components of the present diffractive optics system according to one embodiment thereof;

FIG. 2 is a simplified perspective view of one embodiment of the present diffractive optics system;

FIG. 3 is a side view of the diffractive optics system shown in FIG. 2, illustrating the system in a demultiplexing operating state;

FIG. 4 is a side view of the diffractive optics system shown in FIG. 2, illustrating the system in a multiplexing operating state;

FIG. 5 is a cross sectional view of an optical fiber connected to a waveguide interface as shown in FIG. 4;

FIG. 6 is a simplified perspective view of one embodiment of a diffractive optics system according to another embodiment thereof; and

FIG. 7 is a simplified side view of yet another embodiment of the diffractive optics system.

### DETAILED DESCRIPTION OF THE EXEMPLARY EMBODIMENTS

Reference will now be made to figures wherein like structures will be provided with like reference designations. It is understood that the drawings are diagrammatic and schematic representations of exemplary embodiments of the invention, and are not limiting of the present invention nor are they necessarily drawn to scale.

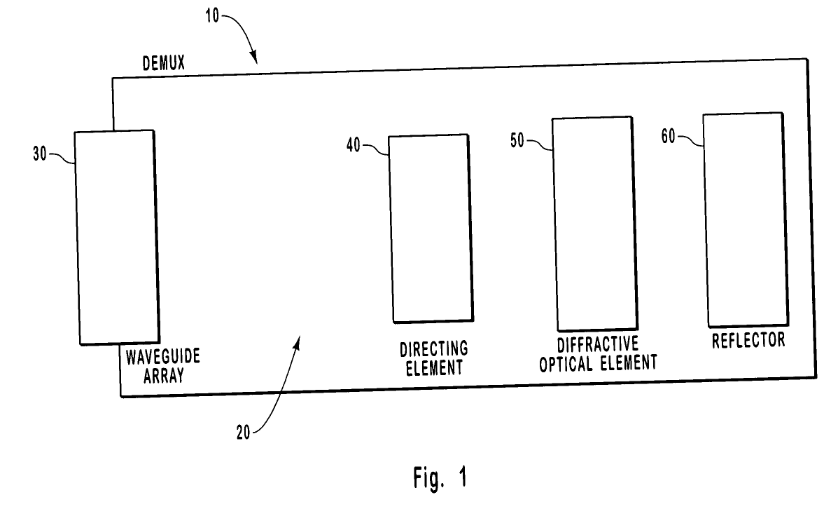

FIGS. 1-7 depict various features of exemplary embodiments of the present invention, which is generally directed to systems and methods for multiplexing and demultiplexing optical signals for use in telecommunications, optical communications networks, and the like. The present system is designed to facilitate optical data transmission at high data rates, for example, 2.5 Gbps (Gigabits per second), 3.5 Gbps, 10 Gbps, 12.5 Gbps, 40 Gbps, and greater than 40 Gbps per optical channel. Further, the present system is compact, requiring only small amounts of space for its operation, thereby extending its utility in small-scale applications prevalent in current data transmission technology.

Reference is first made to FIG. 1, which depicts a simplified block diagram of one implementation in which the present invention can be practiced. FIG. 1 shows a demultiplexing device (“demux”), generally depicted at 10, that is employed to separate discrete, wavelength-distinct channels from a multiplexed optical signal. As used herein, “optical signal” is meant to include at least electromagnetic radiation in the range of near infrared, far infrared, and visible light. More generally, “optical signal” includes the full range of all electromagnetic radiation that can be satisfactorily used to communicate information through a waveguide and/or fiber optic cable. Such a multiplexed optical signal, having a plurality of discrete optical signal channels, can be created using wavelength division multiplexing (“WDM”) and dense wavelength division multiplexing (“DWDM”) to significantly increase the amount of data that can be optically transmitted through a waveguide, such as a fiber optic cable. Multiplexed optical signals can be satisfactorily used in optical communication systems and networks such as local area networks, wide area networks, long haul optical networks, metropolitan area networks, and last mile connections for users of such networks.

The demux 10 shown in FIG. 1 that implements the present invention can be employed as part of an optical communications network, telecommunications network, or the like (not shown). Further, while shown in the embodiments contained herein as having part of a demultiplexing or multiplexing device, the present invention to be described below can be adapted for use in other components, devices and systems. For example, a hand-held spectrum analyzer for analyzing the content of light can also benefit from the present invention. Finally, while the demux 10 is used in demultiplexing a multiplexed optical signal, it can also be employed in a reverse operational state as a multiplexing device for creating a multiplexed optical signal from a plurality of channels, each having distinct wavelengths, as will be described in further detail below.

As shown, FIG. 1 includes various components that together illustrate one embodiment of the present invention, i.e., a diffractive optics system, generally designated at 20. The diffractive optics system 20 in one embodiment generally has several components positioned in series with one another, including a waveguide array 30, a directing element 40, one or more diffractive optical elements (“DOEs”) 50, and a reflector 60. These components cooperate to demultiplex a composite optical signal into discrete optical channels as described above and, in some configurations, to combine channels to form a multiplexed optical signal. These operations are performed by the diffractive optics system 20. Further details concerning each of these components, in addition to the operation of the system as a whole, will be described below.

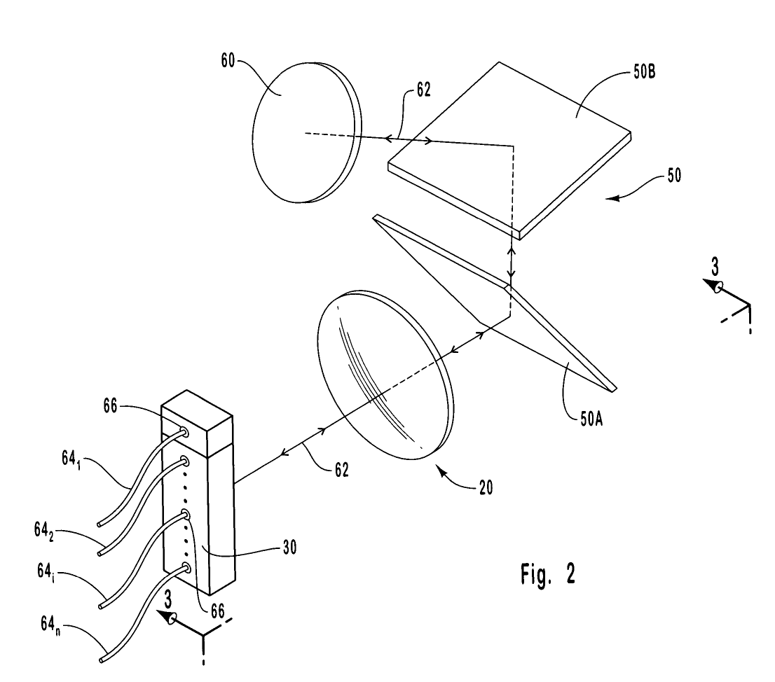

Reference is now made to FIG. 2, which depicts a simplified view of the diffractive optics system 20, as previously discussed in connection with the block diagram of FIG. 1. (The demux 10 has been omitted from the figure for purposes of discussion.) FIG. 2 illustrates the particular positional relationship that exists between the respective components, and further depicts a simplified, general optical path 62 that is approximately followed by optical signals that pass through the diffractive optics system 20 during operation of the demux 10. A plurality of waveguides 64 is shown interconnected with a plurality of arranged ports 66 defined in the waveguide array 30. The waveguide array 30 serves as an interface between the waveguides 64 and the diffractive optics system 20, while the waveguides 64 serve as pathways by which optical signals are input to and/or output from the diffractive optics system 20. Hence, optical signals that are input into the diffractive optics system 20 via one or more of the waveguides 64 are introduced via the waveguide array 30 into the diffractive optics system for travel along the general optical path 62 in connection with multiplexing or demultiplexing operations. Likewise, optical signals that are to be output from the diffractive optics system 20 exit the system via the waveguide array 30 and enter one of the respective waveguides 64. Thus, the waveguides 64 can serve as input or output waveguides. Various commercially available techniques can be used to couple the waveguides 64 to the waveguide array 30. More details regarding the waveguide array 30 are given further below.

In the present exemplary embodiment, the waveguides 64 are optical fibers. In addition to fibers, however, other optical waveguides can alternatively be employed. The waveguide array 30 includes a sufficient number of ports 66 to receive each fiber. A total number of n fibers are received by a corresponding number of n ports that are linearly defined in the waveguide array 30. Thus, as shown in FIG. 2, the fiber waveguides 64 can be designated according to their position in the waveguide array 30, i.e., 64₁ for the first waveguide, 64ᵢ for an intermediate ith waveguide, and 64ₙ for the final waveguide.

In embodiments where the waveguides 64 are fiber optic, the fibers can be single-mode or multi-mode fiber, depending on the desired applications. In addition, the fibers can have small numerical aperture (“NA”) values. Relatively smaller NA values and correspondingly larger core sizes can be achieved in one embodiment by including a thermally expanded core (TEC) at the interface between the fiber and the diffractive optics system 20 to minimize coupling loss. In other embodiments, integration of the directing element 40 with the waveguide array 30 as a micro-lens or lens-let array, or using multi-section fibers for the waveguides 64 can be used to ensure that small NA values are achieved while maintaining an acceptable signal acceptance

Typical dimensions for single mode fiber optic fibers that serve as the waveguides 64 include those having a core diameter of approximately 10 μm, a cladding layer diameter of approximately 125 μm, and a coating layer diameter of approximately 250 μm. Of course, fibers having other dimensions can also be used.

The directing element 40 is located along the general optical path 62 following the waveguide array 30 and is separated therefrom by a specified distance. As its name implies, the directing element 40 is responsible for focusing and/or collimating optical signals that are incident upon the element from either direction within the diffractive optics system 20. In detail, input optical signals that are received by the diffractive optics system 20 via the waveguide array 30 are passed through the directing element 40 in order to collimate the optical signals in preparation for further processing within the system. Similarly, optical signals that have been processed by the diffractive optics system 20 and are traveling toward the waveguide array 30 in preparation for exiting the system pass first through the directing element 40 in order to properly align each signal with a respective one of the waveguides 64. To this end, therefore, the directing element 40 is positioned within the diffractive optics system 20 as to intercept optical signals traveling along the general optical path 62 in order to properly collimate or focus them in the manner described here.

In the illustrated embodiment, the directing element 40 is a bi-convex lens assembly having one or more lenses. In accordance with the operation as described above, however, it is appreciated that other configurations for the directing element 40 can also be employed.

Following the directing element 40 along the general optical path 62 is the DOE 50. As will be described in further detail below, the DOE 50 is responsible for diffracting optical signals in the diffractive optics system 20 such that multiplexing, demultiplexing, or other diffractive operations of the optical signal can occur. In accordance with the exemplary embodiments of the present invention, the diffractive operations performed by the DOE 50, in connection with the other components of the diffractive optics system 20, are able to perform multiplexing and demultiplexing operations on optical signals at high rates, such as 10 Gbps, 40 Gbps, or above due in one embodiment to the minimization of relative path differences of the discrete demultiplexed optical signals, in the demultiplexing case. Thus, the present invention desirably finds application in present communication networks where high speed data transfer is required.

The DOE 50 in the embodiment illustrated in FIG. 2 has multiple components. In particular, a first DOE 50A is positioned in the general optical path 62. A longitudinal axis of the first DOE 50A is angled at a specified angle with respect to a longitudinal axis of the directing element 40 such that proper diffraction by the first DOE is achieved during operation of the diffractive optics system 20. Further details regarding the angled positioning of the first DOE 50A is given further below. In this position, the first DOE 50A is able to transmit and diffract optical signals passing therethrough from either direction along the general optical path 62 within the diffractive optics system 20, as will be seen.

Further along the general optical path 62 is found a second DOE 50B, having a second portion of the DOE 50. Like the first DOE 50A, the second DOE 50B is also responsible for diffracting optical signals passing through its structure. The second DOE is angled with respect to the first DOE 50A at a specified angle such that proper diffraction of the optical signals by the second DOE occurs during operation of the diffractive optics assembly 20, as will be explained. Also, and as was the case with the first DOE 50A, the second DOE 50B is positioned to receive and interact with optical signals traveling from either direction along the general optical path 62.

In the present embodiment, each of the first and second DOEs 50A and 50B is a binary transmission grating. Such a grating performs the necessary diffraction on any incident optical signals as a result of the transmission of the optical signal through the grating. Notwithstanding, however, other diffractive structures can be alternatively employed in the DOE 50. For instance, transmissive holographic diffraction gratings, computer-generated holograms, and surface-relief diffraction gratings can be substituted for the binary gratings of first and second DOEs 50A and 50B, if desired. The diffraction angle of the gratings is kept relatively small (e.g., less than 500) in order to achieve good linearity of optical signal wavelength separation.

Though transmissive diffraction gratings are described as being employed in the present invention, diffractive elements of other types and configurations can also be utilized, as appreciated by one who is skilled in the art. Note that the specific diffractive operations performed by the first and second DOEs 50A and 50B will be discussed further below.

The reflector 60 is located at one end of the optical path 62 of the diffractive optics system 20 beyond the second DOE 50B. The reflector 60 is precisely positioned to reverse the path of any optical signals incident upon it. As shown, the reflector 60 is positioned at a specified angle such that optical signals traveling along the optical path 62 from the second DOE 50B interact with the reflector and are redirected back toward the second DOE in a desired trajectory. Further details regarding this reflection operation will be given further below in explaining the operation of the diffractive optics system 20.

In the illustrated embodiment, the reflector 60 is a mirror. In another embodiment, the reflector 60 can be a retro-prism. In yet other embodiments, various materials and structures can be used to adequately reflect optical signals in the diffractive optics system 20.

Note that the discussion above relates to one embodiment of the present invention, wherein components are positionally arranged as illustrated in FIG. 2. Nevertheless, it is appreciated that other physical configurations between the illustrated or other system components are also envisioned. Correspondingly, the discussion contained herein is not meant to limit the present invention in any way. Further, the present invention should not be construed as to limit the invention to a diffractive optics system containing only these components; rather, components in addition to those explicitly described herein can also form part of the present invention.

The overall optical dimension for the diffractive optics system 20 in one embodiment is about 55 mm×25 mm×8 mm. Of course, the positioning and specific dimensions of the diffractive optics system 20 and its components can be adjusted to be increase or decrease the overall optical dimension of the system, as required by the particular application. The space between each of the optical components in the diffractive optics system 20 can be air, an index-matching epoxy, or any other solid material that a person of ordinary skill in the art deems suitable.

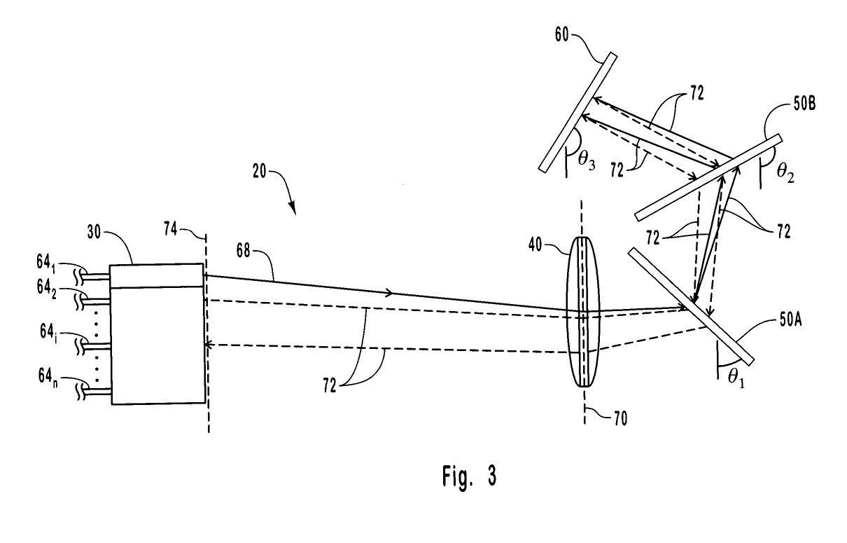

Reference will now be made to FIG. 3, which depicts a side view of the diffractive optics system 20 as shown in FIG. 2 and described in part above. FIG. 3 shows the diffractive optics system 20 in a first operative state, wherein demultiplexing of an optical signal is taking place. This operation can occur, for instance, within a multiplexing/demultiplexing device, such as the demux 10 shown in FIG. 1.

As shown, during the demultiplexing operation a multiplexed optical signal 68, indicated by a so-numbered arrowed solid line portion, is input to the diffractive optics system 20 via an input waveguide 64, that is interconnected with the waveguide array 30. The multiplexed optical signal 68, which has a plurality of combined channels having distinct wavelengths, is directed toward the directing element 40, which directs the optical signal as needed toward the first DOE 50A.

The multiplexed optical signal 68 is then transmitted through the first DOE 50A, which is positioned at an angle θ₁ with respect to a line parallel to a vertical longitudinal axis 70 of the directing element 40. Note here that the description of the relative positions and angular orientations of the elements discussed herein is exemplary only, and does not limit the present invention to only one positional configuration. Rather, the positional descriptions herein are intended to allow a complete description of the present invention to be made. Further, the longitudinal axis 70 of the directing element 40 has been chosen as a point of reference with which the pertinent angles discussed in this application can be measured. Other reference points can, of course, be alternatively chosen.

As a result of being transmitted through the first DOE 50A, the multiplexed optical signal 68 undergoes a first diffraction, which separates the signal into the plurality of wavelength-distinct channels that together previously formed the multiplexed optical signal.

Once separated by the transmission through the first DOE 50A, the channels each proceed toward the second DOE 50B on distinct, diverging paths, which are determined according to the wavelength-dependent dispersion caused by the diffraction at the first DOE 50A. In FIG. 3, two such diffracted channels are depicted at 72 by the so-numbered arrowed solid line portions, though it is appreciated that many times this number of channels can be included in the diffractive optics system 20.

The second DOE 50B is positioned to define an angle θ₂ with respect to a line parallel to the longitudinal axis 70 of the directing element 40 in order to optimize the diffraction ability of the second DOE. Each of the diverging channels 72 resulting from the diffraction of the multiplexed optical signal 68 by the first DOE 50A now proceeds toward the second DOE 50B until interacting with and passing through the second DOE 50B. This interaction further diffracts each of the channels 72, causing additional dispersion between the channels to occur.

After the diffraction through the second DOE 50B, the channels 72 impinge upon and are reflected by the reflector 60, which is positioned at an angle θ₃ with respect to a line parallel to the longitudinal axis 70 of the directing element 40. This reflection causes each of the dispersed channels 72 to be redirected toward (in a specified direction) and transmitted through the second DOE 50B, then through the first DOE 50A. These additional transmissions through the DOEs 50A and 50B result in additional channel dispersion. At the same time however, the reflected channels 72 also become more narrowed and better separated so that any negative effects from the channel dispersion is minimized. The channel dispersion as described above is configured to correspond with the separation between the waveguides 64 in the waveguide array 30 such that each demultiplexed channel is acceptably received by its respective waveguide.

At this point, it is seen that each channel 72 (first as part of the multiplexed optical signal 68, and subsequently as individual channels), has been diffracted by each DOE 50A and 50B two times, resulting in a total of four diffractive interactions. These multiple diffractive interactions enable variation on the passing bandwidth of the optical signals to be minimized and good channel uniformity to be achieved. Further, this technique ensures that adequate channel dispersion is achieved while minimizing the optical path difference between the channels, thereby resulting in the facilitation of high speed demultiplexing by the diffractive optics system 20.

After each of the channels 72 has finally passed through the first DOE 50A, the channels then pass through the directing element 40, which assists in directing each channel to a respective output wave guide 64₂-64ₙ of the wave guide array 30. As a result of the precision with which the DOEs 50A and 50B are manufactured and positioned within the diffractive optics system 20, and in combination with the other components of the system, each of the channels 72 is precisely directed to the proper output waveguide 64₂-64ₙ of the wave guide array 30. To improve the transmission of each channel 72 into the respective waveguide 64, the end of each waveguide as positioned in the waveguide array 30 can terminate at a point coinciding with a focal plane 74 of the directing element 40, as seen in FIG. 3.

Upon entering respective waveguide 64, each de-multiplexed channel 72 exits the diffracted optics system 20 and the demux device 10 (FIG. 1). So transmitted, each channel 72 can then be forwarded for use in an optical communications or telecommunications network (not shown), or for use in other applications as appreciated by those skilled in the art.

The de-multiplexing and multiplexing operations made possible by the diffractive optics system 20 as described in the above paragraphs are configured to enable high speed data transfer. In addition, the present invention is able to minimize optical path difference while maximizing channel dispersion. This results in a compact channel geometry, which reduces delay time and further facilitates high speed data transmission. Thus, the present diffractive optics system 20 represents a significant advantage over the art.

In addition, passing band shaping and the passing bandwidth ratio of each channel can be simultaneously controlled through the use of the first and second DOEs 50A and 50B used herein. In detail, the passing band of each channel is maximized in the present invention by controlling the TEC fiber core size of the waveguides 64, as well as precisely controlling the angle at which a channel impinges on a respective waveguide at the waveguide array. These parameters can be adjusted, thereby enabling control of the passing bandwidth ratio. A 1 dB passing bandwidth ratio can be realized in the present invention, which exceeds that possible in other known designs, such as array waveguides.

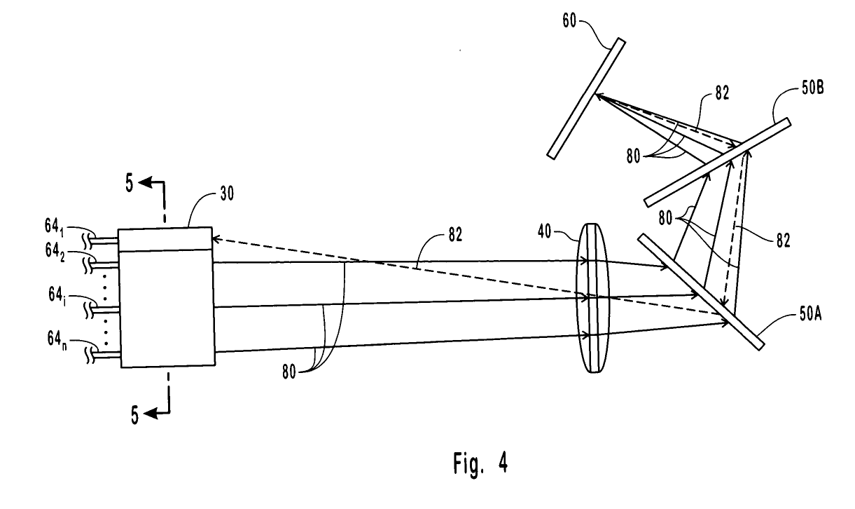

Reference is now made to FIG. 4, which depicts the diffractive optics system 20 in a second operating state. In detail, FIG. 4 shows the diffractive optics system 20 combining various wavelength-distinct channels into a single, multiplexed optical signal for use in an optical communications network, telecommunications network, or similar application. A process conversely similar to that described in connection with FIG. 3 is followed in the present operating state to produce a multiplexed optical signal. Specifically, a plurality of optical signal channels 80, each having a distinct wavelength, is inputted into the diffractive optics system 20 via a plurality of the waveguides 64₂-64ₙ. The channels 80 are focused by the directing element 40, then transmitted through each of the first and second DOEs 50A and 50B. Passage through each of the first and second DOEs 50A and 50B diffracts each channel 80 a small degree, which causes the channels to mutually converge. After initial passage through each of the DOEs 50A and 50B, the channels 80 are reflected by the reflector 60 and directed toward the DOEs for a second passage through each. This second passage through both the second DOE 50B (first) and the first DOE 50A (second) converges the channels 80 even further until the channels are combined into a single multiplexed optical signal 82. The multiplexed optical signal 82 is then focused as needed by the directing element 40, and directed to the output waveguide 64, (or another designated waveguide) for forwarding to an optical network or the like. Again, by virtue of the present invention, high speed multiplexing is possible, thereby enabling rates of at least 40 Gbps to be achieved.

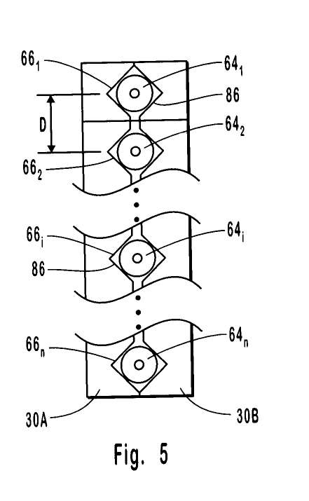

FIG. 5 depicts one view of the waveguide array 30 shown in FIG. 4. In one embodiment, the wave guide array 30 is comprised of two pieces 30A and 30B that are mated to define the array. “V-groove” notches 86 are defined on the mating surfaces of each of the pieces 30A and 30B such that the plurality of n ports 66 are defined when pieces are brought together. The V-groove notches are sized and positioned such that a precise distance “D” (shown in FIG. 5) separates corresponding portions of adjacent waveguides 64. So arranged, the ports 66 enable each of the waveguides 64 to be seated between the V-groove notches 86 that define the respective port 66. In this way, each of the waveguides 64₁-64ᵢ-64ₙ is precisely positioned by the waveguide array 30 so as to transmit and receive optical signals to and from the diffractive optics system 20. Such precision is beneficial in the present invention due to the precise trajectories imparted to the outgoing channels by the diffractive optics system 20 in a demultiplexing operation, for instance. In one embodiment, the distance D is about 130 μm. The distance D is at least partly determined by extent of channel diffraction within the diffractive optics system 20 as well as the separation distance between adjacent channels. It should be noted here that waveguide arrays having differing structure and configuration can be alternatively employed to accomplish the function described herein. For instance the distance D can be greater or less than 130 μm

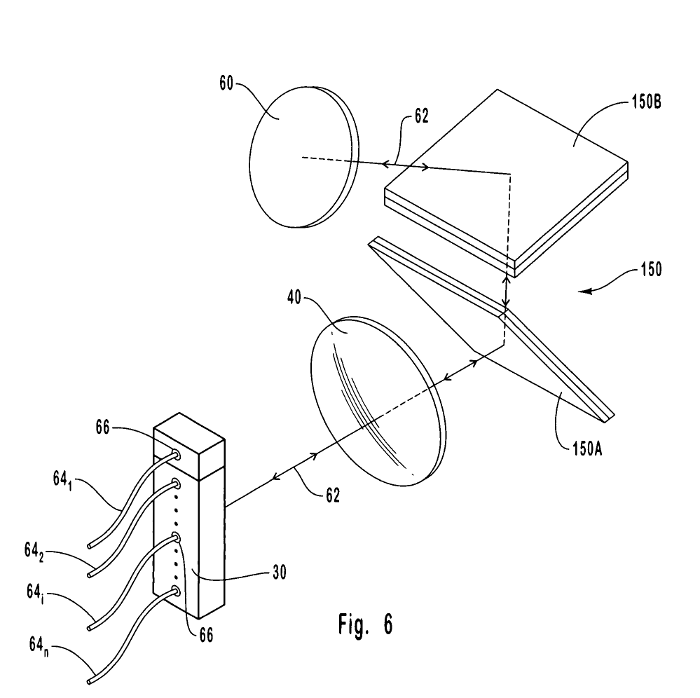

Reference is now made to FIG. 6. As previously mentioned, the DOE employed in the diffractive optics system of the present invention can include one of a variety of diffractive components that serve as a means for repeatedly transmitting and diffracting a directed optical signal, as described above. For example, in the embodiment described in FIGS. 3 and 4, the means for repeatedly transmitting and diffracting a directed optical signal includes the first and second DOEs 50A and 50B, which repeatedly transmit and diffract optical signals as part of a multiplexing or demultiplexing operation.

FIG. 6 represents another embodiment of the present invention, wherein the DOE includes another type of diffractive structure that serves as another example of a means for repeatedly transmitting and diffracting a directed optical signal. In particular, FIG. 6 depicts the diffractive optics system 20, wherein the transmissive binary gratings of the DOEs 50A and 50B are replaced by first and second DOEs 150A and 150B, respectively, that are transmissive holographic gratings. The transmissive holographic gratings that here form part of the first and second DOEs 150A and 150B operate similarly to the transmissive binary gratings of FIGS. 2-4 in diffracting and combining optical signals in demultiplexing and multiplexing operations within the diffractive optics system 20.

It is appreciated that the transmissive holographic gratings of the DOEs 150A and 150B in FIG. 6 are only one example of a means for repeatedly transmitting and diffracting an optical signal by virtue of passing it through diffractive optical elements, such as transmissive grating structures a specified number of times, as already explained. Other diffractive structures, in addition to those already discussed herein, can also be used as DOEs in the present invention. For instance, in addition to those already described, computer-generated holograms, surface-relief gratings and other diffractive structures can be employed as DOEs. Further, a first DOE of one type (such as a surface-relief grating) can be used in the system with a second DOE of another type (such as a holographic grating), if desired. Moreover, in some embodiments, only one DOE may be employed, if desired, to accomplish selected dispersion or combination of optical signal channels in certain applications. DOEs including pairs of diffractive structures can be utilized as well. Finally, more than two DOEs can be included in the system, if desired.

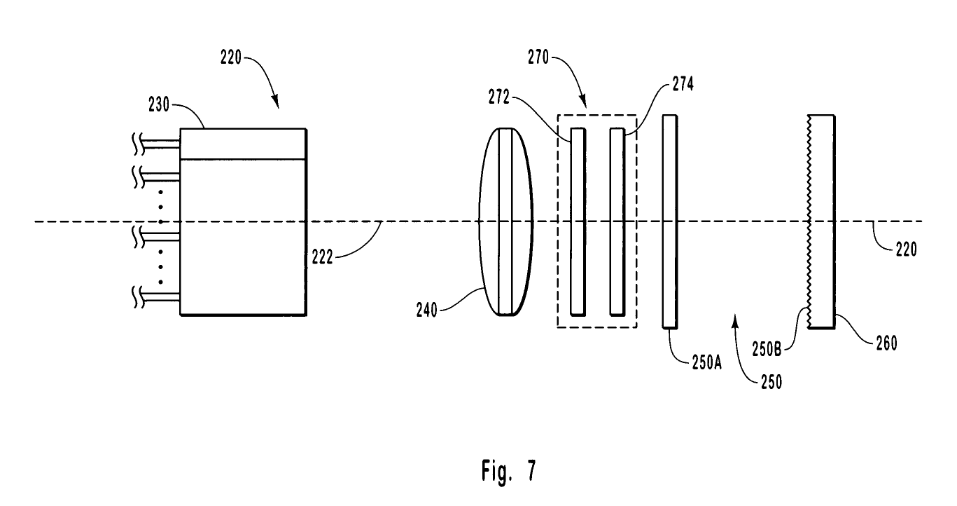

Reference is now made to FIG. 7, which depicts yet another embodiment of the present invention. As before, this embodiment includes a diffractive optics system, generally depicted at 220, which includes a waveguide array 230, a directing element 240, a DOE 250, and a reflector 260. The various components of the diffractive optics system 220 in this embodiment, however, are linearly arranged along a common longitudinal axis 220.

The positional arrangement of FIG. 7 may be desired in certain applications where folding of the diffractive optics system is not possible or desirable, or when the diffraction resulting from the present arrangement is preferred over other configurations, or when simpler system packaging is desired. For instance, the overall length of the arrangement shown in FIG. 7 is shorter than in other embodiments. However, system performance is not compromised, thereby enabling small numerical apertures and larger passbands to be maintained in the system.

In addition, though the DOE 250 in the embodiment shown in FIG. 7 has a first DOE 250A and second DOE 250B, the second DOE is mated with the reflector 260. This can add simplicity to the system by reducing the number of discrete components and overall length of the system while, at the same time, preserving the desired operation thereof.

FIG. 7 also shows the addition of a polarization dependent loss (“PDL”) assembly 270. PDL is an artifact of optical multiplexing and demultiplexing, and may undesirably interfere with operation of the systems disclosed by the present invention. PDL can be minimized by the PDL assembly 270, which generally includes a birefringent element 272 and a 1/2-wave plate 274. The PDL assembly 270 is positioned in this exemplary configuration between directing element 240 and the DOE 250. During operation of the diffractive optics system 220 (or the other systems disclosed herein having a PDL assembly), the birefringent element 272 and the 1/2-wave plate 274 cooperate to reduce PDL in the optical signals that are input and output from the diffractive optics system. Such use of birefringent materials and wave plates is known in the art and the PDL assembly 270 can be modified in configuration, position, and components as contemplated by one skilled in the art. A PDL assembly (such as that shown here) or similar assembly can be included in the other embodiments depicted in the accompanying drawings as well. In addition, the ½-wave plate can be replaced by other components that perform the same function, such as two ¼-wave plates placed in series.

Many of the components of the diffractive optics systems illustrated herein, namely, the waveguide array, the directing element, and the DOE, can be configured in a telecentric mode. This enables an input optical signal originating from an input waveguide to return to the waveguide array after passage through the diffractive optics system with a similar inclination relative to an optical axis that extends through the center of each component in the system.

The present invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A diffractive optics system, comprising:
a directing element that directs an inputted optical signal;
means for repeatedly transmitting and diffracting the directed optical signal into multiple channels of distinct wavelengths; and
a reflector that receives the multiple channels from the means for repeatedly transmitting and diffracting and reflects the multiple channels back toward the means for repeatedly transmitting and diffracting.

2. A diffractive optics system as defined in claim 1, wherein the multiple channels that are reflected by the reflector are transmitted through the means for repeatedly transmitting and diffracting.

3. A diffractive optics system as defined in claim 1, wherein the multiple channels are transmitted through the means for repeatedly transmitting and diffracting at least two times.

4. A diffractive optics system as defined in claim 1, wherein the directing element includes a bi-convex lens.

5. A diffractive optics system as defined in claim 1, wherein the reflector is chosen from the group consisting of mirrors and retroprisms.

6. A diffractive optics system as defined in claim 1, wherein the means for repeatedly transmitting and diffracting is angled with respect to directing element and the reflector.

7. A diffractive optics system as defined in claim 1, wherein the means for repeatedly transmitting and diffracting comprises:
a first diffractive optical element; and
a second diffractive optical element positioned at an angle with respect to the first diffractive optical element.

8. A diffractive optics system as defined in claim 7, wherein the first and second diffractive optical elements comprise binary transmission gratings.

9. A diffractive optics system as defined in claim 7, wherein the second diffractive optical element is attached to the reflector.

10. A diffractive optics system as defined in claim 1, further comprising a waveguide array that includes at least one input waveguide that directs the inputted optical signal toward the directing element, the waveguide array further including at least two outlet waveguides that are positioned to receive the multiple channels from the means for repeatedly transmitting and diffracting.

11. A diffractive optics system as defined in claim 1, wherein the system is capable of multiplexing multiple channels into a combined an optical signal.

12. In an optical device, a diffractive optics system, comprising:
a waveguide array including an input fiber that directs an optical signal into the diffractive optics system;
a directing element that directs the optical signal;
a first diffractive optical element (“DOE”) positioned to perform a first diffraction of the optical signal;
a second DOE positioned in an angled configuration with respect to the first DOE to perform a second diffraction of the optical signal; and
a reflector positioned to reflect the twice-diffracted optical signal back toward the second DOE.

13. A diffractive optics system as defined in claim 12, wherein the twice-diffracted optical signal is reflected by the reflector such that it passes through the first and second DOEs.

14. A diffractive optics system as defined in claim 12, wherein at least a portion of the waveguide array is positioned proximate a focal plane of the directing element.

15. A diffractive optics system as defined in claim 12, wherein the first and second DOEs comprise transmission diffraction gratings, and wherein the optical signal is transmitted through the first and second DOEs during the first and second diffractions.

16. A diffractive optics system as defined in claim 15, wherein the first and second DOEs are selected from the group consisting of binary diffraction gratings, holographic diffraction gratings, surface-relief diffraction gratings, and computer-generated holograms.

17. A diffractive optics system as defined in claim 12, further including a polarization dependent loss prevention assembly interposed between the directing element and the first DOE.

18. A diffractive optics system as defined in claim 17, wherein the polarization dependent loss prevention assembly comprises a birefringent element and a ½-wave plate.

19. A diffractive optics system as defined in claim 12, wherein the directing element, first DOE, second DOE, and reflector are positioned in a folded arrangement such that they are angled with respect to one another.

20. A diffractive optics system as defined in claim 12, wherein the optical device is selected from the group consisting of a wavelength division multiplexing/demultiplexing device, an add/drop multiplexer, and a spectrum analyzer.

21. A method of demultiplexing an optical signal, comprising:
directing a multiplexed optical signal along a predetermined path;
performing a first diffraction of the multiplexed optical signal to separate the multiplexed optical signal into a plurality of channels having distinct wavelengths;
performing a second diffraction to further disperse the plurality of channels;
reflecting the plurality of channels after the second diffraction; and
outputting the plurality of channels to a plurality of waveguides

22. A method of demultiplexing as defined in claim 21, wherein the first and second diffractions are respectively performed by a first transmissive diffraction grating and a second transmissive diffraction grating.

23. A method of demultiplexing as defined in claim 22, further comprising:
after reflecting the plurality of channels, transmitting the plurality of channels through the first and second DOEs.

24. A method of demultiplexing as defined in claim 21, wherein outputting the plurality of channels further comprises:
outputting the plurality of channels into discrete fiber optic waveguides positioned in a waveguide array.

25. A diffractive optics system capable of multiplexing and demultiplexing optical signals, comprising:
a waveguide array including a plurality of fiber optic waveguides capable of carrying optical signals;
a lens assembly for directing optical signals;
a first transmissive diffraction grating positioned in series with the lens assembly;
a second transmissive diffraction grating positioned in series with the first transmissive diffraction grating; and
a reflector positioned in series with the second transmissive diffraction grating, the reflector enabling optical signals that have passed through the first and second transmissive diffraction gratings to be re-transmitted through the first and second transmissive diffraction gratings.

26. A diffractive optics system as defined in claim 25, wherein the first and second diffraction gratings comprise binary transmissive diffraction gratings.

27. A diffractive optics system as defined in claim 26, wherein the first and second transmissive diffraction gratings are angled with respect to one another.

28. A diffractive optics system as defined in claim 27, wherein the lens assembly and the reflector are angled with respect to the first and second transmissive diffraction gratings.

29. A diffractive optics system as defined in claim 28, wherein passage of an inputted optical signal through the system demultiplexes the optical signal into a plurality of wavelength-distinct channels.

30. A diffractive optics system as defined in claim 28, wherein passage of a variety of wavelength-distinct optical signal channels through the system combines the optical signal channels into a multiplexed optical signal.

31. A diffractive optics system as defined in claim 28, wherein the lens assembly, the first and second transmissive diffraction gratings, and the reflector are positioned in a telecentric mode.
